(19) United States
(12) Patent Application Publication
(10) Pub. No.: US 2024/0200159 A1
(43) Pub. Date: Jun. 20, 2024

(54) METHOD FOR COMPOUND STRENGTHENING TREATMENT OF GEAR SURFACE

(71) Applicant: GUANGXI UNIVERSITY, Nanning (CN)

(72) Inventors: Yong CHEN, Nanning (CN); Hui YOU, Nanning (CN); Xiaoze LIN, Nanning (CN); Guangxin LI, Nanning (CN); Jie CHEN, Nanning (CN); Yanjun TAN, Nanning (CN); Li LUO, Nanning (CN)

(21) Appl. No.: 18/080,810

(22) Filed: Dec. 14, 2022

(51) Int. Cl. C21D 7/06; C10M 103/06

(52) U.S. Cl. CPC C21D 7/06; C10M 103/06; C10M 2201/066; C10N 2050/04

(57) ABSTRACT

Disclosed is a method for a compound strengthening treatment of a gear surface, belonging to the technical field of gear surface treatment, including following steps: firstly, performing a compound shot peening treatment on the gear surface, and then performing molybdenum disulfide micro-particle thermal spraying on the obtained gear surface to complete the compound strengthening treatment on the gear surface.

### TECHNICAL FIELD

The application belongs to the technical field of gear surface treatment, and particularly relates to a method for a compound strengthening treatment of a gear surface.

### BACKGROUND

Low-carbon alloy steel gears have a good hardenability, a good strength and a good yield strength, and are superior to ordinary carbon steels in terms of an oxidation resistance, a corrosion resistance, a heat resistance, a low temperature resistance, a wear resistance and special electromagnetism, so the low-carbon alloy steel gears are widely used in transmission machinery such as automobile transmission and high-speed railway. With a development of a transmission system in a direction of high speed, high torque, miniaturization and light weight, higher requirements are put forward for a fatigue strength and a fatigue life of the gears. The low-carbon alloy steel gears that only adopt a carburizing and quenching heat treatment process may not meet the requirements for the fatigue strength and the fatigue life of transmission gears under harsh working conditions, the high speed and the high torque.

Shot peening is a widely used surface strengthening method below a recrystallization temperature. The shot peening of the low-carbon alloy steel gears may significantly improve a bending fatigue resistance and a contact fatigue resistance. At the same time, the shot peening has advantages of a simple operation, a low energy consumption, a high efficiency and a wide application range. A compound shot peening strengthening technology firstly uses high-hardness and large shots for the shot peening at a high pressure and a high speed, and then uses small-diameter high-hardness shots for the shot peening to form a compound residual compressive stress on a gear surface, improve a surface roughness, significantly increase the residual compressive stress near a tooth surface, and then inhibit the development of gear fatigue cracks.

CN101530985A discloses a compound shot peening method considering both surface strengthening and polishing. After shot peening twice, the residual compressive stress on a surface and a near-surface area is increased, a microhardness of the surface and the near-surface area is improved, a surface roughness of parts is significantly reduced, and a surface quality of shot peened materials is improved. However, toughness of the gear surface has decreased, and fatigue pitting and peeling problems of the gear have worsened.

Compound shot peening for the gears may improve a bending fatigue strength and a wear resistance of the gears to a certain extent, but an improvement of the wear resistance is limited. Meanwhile, the roughness and the toughness of the gear surfaces may decrease, and the fatigue pitting and peeling problems of the gears may get worse.

In order to enhance the wear resistance of the gears, Li Guoyun et al. made molybdenum disulfide into 0.3 mm particles, and shot peened tooth surfaces of steel worm gear pairs with molybdenum disulfide micro-particles, so that the tooth surfaces are coated with molybdenum disulfide solid lubrication layers (see “Transmission Performance of Surface Modified Steel Worm Gear Pairs”, Li Guoyun, Jiang Hongwei, Chen Yong, et al., Journal of Lanzhou University of Technology, 2009, 35(5): 32-35). Although this technology may improve the wear resistance of the gear surfaces, the molybdenum disulfide micro-particles are too large, and there are residues on the gear surfaces after the shot peening. Besides, the hardness of the particles made of molybdenum disulfide is low, a shot peening strength is not big enough, and the residual compressive stress and a surface hardness of the gears are limited, so the fatigue strength of the materials may not be effectively improved.

Therefore, there is an urgent need to overcome the defects in the compound shot peening and molybdenum disulfide particle spraying, and to combine the two methods effectively, so as to exert the greatest strengthening effect on the gear surfaces, improve a contact fatigue strength of the gears and prolong a service life of the gears.

### SUMMARY

In order to solve the above problems in the prior art, the application provides a method for a compound strengthening treatment of a gear surface.

To achieve the above objective, the application provides a following technical scheme:
the application provides a method for compound strengthening treatment of the gear surface, including following steps: firstly, performing a compound shot peening treatment on the gear surface, and then performing molybdenum disulfide micro-particle thermal spraying on the obtained gear surface, and completing the compound strengthening treatment on the gear surface.

In an embodiment, the compound shot peening treatment is two shot peening, the first shot peening uses shots with a diameter of 0.2-0.25 mm for the shot peening of the gear surface, and the second shot peening uses the shots with the diameter of 0.1-0.15 mm for the shot peening of the gear surface.

In an embodiment, a shot peening angle of the two shot peenings is 80-100°, a shot flow rate is 4-6 kg/minute, and a spraying distance is 150-170 mm; and shot peening coverage is 180-220%.

Shot peening strengthening is a controlled shot peening technology that continuously impacts the gear surface with a high-speed shot flow to make the gear surface deform plastically under an impact of the shot flow. This influence extends to a surface layer of a gear material, and produces favourable changes such as a high residual compressive stress, work hardening and a microstructure refinement to counteract a bad tensile stress. The residual compressive stress delays a formation of fatigue fracture, effectively improves a fatigue strength of the gear, and prolongs a service life of the gear.

There are many parameters that affect a shot peening strengthening effect, such as a shot diameter, a shot speed, a shot flow rate, a spraying angle, a spraying duration, a spraying distance, coverage and so on. The change of any one of these parameters may affect a shot peening strength and an effect of the shot peening. There are two basic parameters to evaluate a quality of the shot peening: the shot peening strength and the coverage. The coverage is measured by visual inspection, while the shot peening strength needs to be measured by ALMEN test pieces.

The shot peening angle refers to the angle between the speed of each shot and the gear surface. Under certain other parameters, the larger the shot peening angle, the greater the energy of each shot perpendicular to the gear surface, and the more energy transferred to the gear surface for plastic deformation, resulting in an increase of a maximum residual compressive stress. On the other hand, with the increase of shot peening angle, a tangential velocity of each shot decreases, and a crater extrusion on a direction of the shot peening decreases, thus making the maximum residual compressive stress decrease. Because the direction of a residual compressive tensile stress is parallel to the tangential velocity of each shot, the main influence on a magnitude of the velocity is a normal velocity. With the increase of the shot peening angle, the normal velocity of the shot increases, and the maximum residual compressive stress on the surface also increases gradually, but an increasing amplitude decreases. In a word, the maximum residual compressive stress and a depth of a residual compressive stress layer increase with the increase of the shot peening angle. When the shot peening angle reaches 90°, a kinetic energy of each shot may be transformed into a plastic deformation energy of the material to the greatest extent. In order to obtain greater stress value and stress layer depth, the shot peening angle may be set at 90°.

In an embodiment, the shots used in the two shot peenings are cast steel shots or ceramic shots; hardness of the cast steel shots or the ceramic shots is 58-63 HRC.

In an embodiment, a raw material used for the molybdenum disulfide micro-particle thermal spraying is a molybdenum disulfide solid lubricant, and the molybdenum disulfide solid lubricant is mixed with the shots with a particle size of 0.03-0.2 mm to form the molybdenum disulfide micro-particles.

In an embodiment, the shots are ceramic shots, and a mass ratio of the molybdenum disulfide solid lubricant to the ceramic shots is 20-30:1.

In an embodiment, an inert gas is used as a carrier gas of the molybdenum disulfide micro-particles during the molybdenum disulfide micro-particle thermal spraying.

In an embodiment, in a process of thermal spraying, a shot peening pressure is 0.3-0.6 MPa, and a shot peening duration is 30-50 seconds.

Compared with the prior art, the application has following beneficial effects.

(1) In the application, the shots adopting a compound small-diameter shot peening+molybdenum disulfide micro-particle thermal spraying treatment process have higher hardness and specific gravity, so it is not easy to generate a large amount of dust and free silica in a treatment process, injuries of workers in the treatment may be effectively reduced, and pollution of ambient air may also be reduced.

(2) The compound small-diameter shot peening+molybdenum disulfide micro-particle thermal spraying treatment process is to use the shots to impact the gear surface to form many fine holes. A shot quantity of the shots may be adjusted with a surface area of the gear, so a large surface processing capacity may be achieved.

(3) The shots impact the gear surface at a high speed, making the impacted gear surface generate a high temperature and soften a structure of the gear; as a result, an internal part is compressed and an external stress is reduced, thus making the gear have toughness and high hardness.

(4) The molybdenum disulfide micro-particle thermal spraying treatment process is to use the shots to impact the gear surface to form a plurality of fine holes, so that the solid lubricant (molybdenum disulfide) adheres to the gear surface, and greatly improves a self-lubricating type of the gear surface.

(5) The molybdenum disulfide micro-particle thermal spraying treatment process makes the gear surface coated with grease for lubrication, and the grease may produce an oil film. Because of the fine holes formed on the gear surface, a friction and an adsorption force between the oil film and the gear surface are increased, making the oil film adhere to the gear surface for a long time without being easily blocked and with a high lubricity, thus avoiding an abrasion caused by the friction between the gear and other workpieces.

(6) Because the shots impact the gear surface at a high speed, the gear surface may generate a high temperature; nitrogen at normal temperature and low temperature (0° C.) may be introduced simultaneously by using a gas generator and a cooler together with a first nozzle and a second nozzle, so that the gear surface may have an effect of rapid heating and rapid cooling; and a quenching effect achieved by alternating cold and hot is beneficial to an improvement of hardness of the gear surface.

(7) Because the nitrogen introduced at low temperature (0° C.) may condense moisture in the air of an operation cabin, and bring the moisture to an aggregate cabin with a recovery step, the moisture in the aggregate cabin may be preheated by a heater to evaporate, so as to facilitate a flow of the shots, and further improve a processing efficiency and a service life.

(8) Strengthening the gear surface by the compound small-diameter shot peening+molybdenum disulfide micro-particle thermal spraying treatment process according to the application may generate the residual compressive stress on the gear surface, improve the hardness of the gear surface, improve the lubricity of the gear surface, reduce a friction coefficient of the gear surface, improve a lubricating ability and a surface smoothness, and further improve a fatigue life of the gear.

### BRIEF DESCRIPTION OF THE DRAWINGS

In order to more clearly explain embodiments of the application or technical solutions in the prior art, the following briefly introduce drawings to be used in the embodiments. Obviously, the drawings in the following description are only some embodiments of the application. For those of ordinary skill in the art, other drawings may be obtained according to these drawings without any creative effort.

FIG. 1 is a physical map of a compound shot peening device adopted in embodiment 1 according to the application.

FIG. 2 is a physical map of a molybdenum disulfide spraying device used in embodiment 1 according to the application.

FIG. 3A and FIG. 3B are outside views of a gear before and after a treatment in embodiment 1, respectively.

FIG. 4 is a comparison diagram of residual stresses of a gear before and after a treatment in embodiment 1.

FIG. 5 shows hardness test results of a gear surface before and after a treatment in embodiment 1.

FIG. 6 is a physical map of a test bed used for a fatigue life test of a gear before and after a treatment in embodiment 1.

FIG. 7 is a graph of fatigue life test results of a gear before and after a treatment in embodiment 1.

FIG. 8 is the physical map of an SRV testing machine of Optimol Instrument Company of Germany used in a friction coefficient test.

### DETAILED DESCRIPTION OF THE EMBODIMENTS

Now various exemplary embodiments of the application may be described in detail. This detailed description should not be taken as a limitation of the application, but should be understood as a more detailed description of some aspects, characteristics and embodiments of the application. It should be understood that terms mentioned in the application are only used to describe specific embodiments, and are not used to limit the application.

In addition, for a numerical range in the application, it should be understood that each intermediate value between an upper limit and a lower limit of the range is also specifically disclosed. Every smaller range between any stated value or an intermediate value within the stated range and any other stated value or the intermediate value within the stated range is also included in the application. The upper and lower limits of these smaller ranges may be independently included or excluded from the range.

Unless otherwise stated, all technical and scientific terms used herein have the same meanings commonly understood by those of ordinary skill in the field to which this application relates. Although the application only describes preferred methods and materials, any methods and materials similar or equivalent to those described herein may be used in the practice or testing of the application. All documents mentioned in this specification are incorporated by reference to disclose and describe the methods and/or materials related to the documents. In case of conflict with any incorporated documents, the contents of this specification shall prevail.

Without departing from a scope or spirit of the application, it is obvious to those skilled in the art that many modifications and changes may be made to the specific embodiments of the present specification. Other embodiments obtained from the description of the application may be obvious to the skilled person. The description and embodiment of that application are only exemplary.

As used in this paper, the terms “comprising”, “including”, “having” and “containing” are all open terms, meaning including but not limited to.

Gears of all the embodiments and comparative examples of the application are low-carbon alloy steel gears with a same specification in a same batch, and have undergone a same carburizing and quenching heat treatment process, and molybdenum disulfide solid lubricants used are all the same.

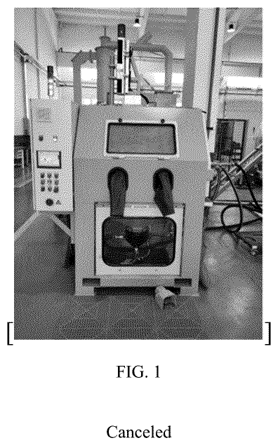

In the following embodiments and comparative examples, a shot peening device used for a compound shot peening treatment on a gear surface is commercially available, and its physical map is shown in FIG. 1. The device is mainly composed of eight mechanical systems and an electrical control system. Eight systems include a shot peening chamber, a parts movement system, a spray gun movement system, a shot recovery system, a shot separation system, a shot storage system, a shot peening generation system and an environmental protection dust removal system. The electrical control system refers to electrical hardware and electrical software.

Shot peening chamber: a rubber protective layer is attached to the whole shot peening chamber to prevent shots from being damaged by sputtering, and a manganese steel protective plate is hung outside the rubber layer in a shot peening orthophoto area to prolong a service life of the chamber. Shot material recovery system: it is mainly used to recover and recycle the shots in a process of shot peening, so as to prevent an accumulation of the shots from affecting a shot peening effect. Shot material separation system: the shot separation system is used to screen the recovered shots, screen out the unqualified shots, and put the qualified shots into a silo. Shot material storage system: the shot storage system mainly includes the silo, a configurable automatic feeding system, a material level alarm, etc. Shot peening generation system: the shot peening generation system is equipped with a pressure tank for shot peening strengthening. Environmental protection dust removal system: according to corresponding environmental protection standards, the dust removal system is divided into a dry dust collector and a wet dust collector. Generally, for flammable and explosive materials such as aluminum-magnesium alloy, the wet dust collector (also known as “water dust collector”) may be selected and equipped with an explosion-proof device.

The electrical control system:
the electrical hardware is mainly an electrical cabinet.

The electrical software is mainly an electrical operation interface, which may be set according to needs, and is mainly divided into “host monitoring”, “shot peening monitoring”, “parameter setting”, “parameter library”, “maintenance prompt”, “vulnerable parts prompt”, “alarm prompt” and “technical support”.

In the following embodiments and comparative examples, the device used for molybdenum disulfide micro-particle thermal spraying on the gear surface is commercially available, and the device mainly consists of a spraying device, an air compressor, a gas generator, a cooler, etc.

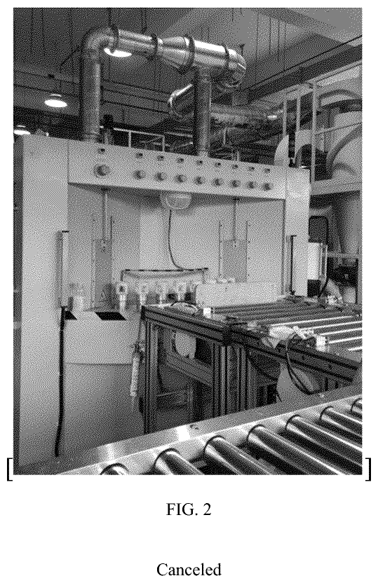

Among them, the physical map of the molybdenum disulfide spraying device is shown in FIG. 2, and the device has an aggregate cabin, an operation cabin communicating with the aggregate cabin, a collector communicating with the operation cabin, a heater arranged on the aggregate cabin, two nozzles arranged in the operation cabin, and an exhaust assembly arranged on the collector.

The description will not be repeated below.

### Embodiment 1

A compound strengthening treatment of the gear surface includes following steps.

1. Firstly, the compound shot peening treatment is carried out on the gear surface, and the shot peening is performed twice with the shots with different diameters. The first time is to use the shots with the diameter of 0.15-0.2 mm for the shot peening on the gear surface, and the second time is to use the shots with the diameter of 0.1-0.15 mm for the shot peening on the gear surface. The first shot peening is mainly to obtain a large stress value and a large stress layer depth, and the shots with a large diameter are used, with a diameter range of 0.15-0.2 mm; the second shot peening is mainly to reduce the depth of a maximum residual stress value and a roughness of the gear surface, so the shots with the a small diameter are used, and the diameter range is 0.1-0.15 mm.

The shots used in the two shot peenings are cast steel shots or ceramic shots, and hardness of the cast steel shots or the ceramic shots is 58-63 HRC. The steps of the two shot peening treatments are the same, and the specific steps are as follows.

### 1.1 Preparation Steps

Firstly, the shots are loaded into the silo in the shot storage system and transported to the shot peening chamber by the feeding system.

In this embodiment, the shots used in the two shot peenings are the cast steel shots with a density of 7.8 g/mL and the hardness of 58-63 HRC.

### 1.2 Shot Material Filtration

Intact shots are sucked into the pressure tank by a cyclone separator in the shot separation system, unqualified shots are screened out, and the dust is sucked away by the dust collector in the environmental protection dust removal system.

### 1.3 Spraying Step

The shot peening is started, and a mushroom head above the pressure tank in the shot peening generation system pushes up to seal the pressure tank. The shots are sprayed to the gear surface by compressed air through the spray gun in the spray gun movement system.

In the two shot peening processes of this embodiment, a shot peening angle is 90°. A shot flow rate is related to a shot peening pressure, a shot diameter and a nozzle diameter, etc. In this embodiment, the nozzle diameter for the two shot peening treatments is 8 mm, the first shot peening pressure is 0.42 MPa, the first shot diameter is 0.2-0.25 mm, the second shot peening pressure is 0.22 MPa, the second shot diameter is 0.1-0.15 mm, and the shot flow rate for the first shot peening and the second shot peening is 5 kg/minute. The shot peening coverage is set to 200%, a duration of the two shot peenings is set to be 120 seconds, and a spraying distance is set to 160 mm.

### 1.4 Recovery Steps

After the shots impact the gear surface, most of the shots directly fall to a bottom of the shot peening chamber, and the broken fine dust is sucked into the dust collector by a dust removal fan. A bottom spiral blade pushes the shots to an elevator, and the elevator lifts the shots to a top sorter, and then the shots enter a vibrating screen; the vibrating screen screens the oversized and undersized shots into a waste hopper, and the qualified shots enter the silo, and the shots in the silo enter the spray gun through the pressure tank.

After the compound shot peening, the actual shot peening coverage and the shot peening strength are detected, and a detection method for the shot peening coverage is: the gear surface may be coated with fluorescent liquid before the shot peening, and the shot peening surface may be observed with a magnifying glass of 10-30 times after the shot peening, and a percentage of the removed fluorescent liquid in a total area may be visually observed, so as to obtain the shot peening coverage. In reality, when the coverage reaches more than 98%, it is difficult to measure. Usually a shot peening duration reaching 98% coverage is taken as a full coverage duration, considering that the coverage reaches 100% at this time. If the required coverage reaches 200%, the full coverage duration may be doubled. In order to make the gear surface shot peening uniform and obtain a greater depth of the stress layer, the shot peening coverage is set at 200%. In this embodiment, each shot peening duration is 120 seconds, and the coverage of two shot peening is 200%.

The shot peening strength is related to a shot peening speed, the shot diameter, a spraying angle and other factors. The shot peening strength is measured by an ALMEN arc height measurement method. There are three kinds of ALMEN test pieces: N-type test piece, A-type test piece and C-type test piece, all of which are made of SAE1070 spring steel. Under an impact of the shot on one side, a surface layer of the test piece is plastically deformed, thus causing the test piece to bend spherically toward a spraying surface. The distance between a specific reference plane cut into a sphere and the highest point of the sphere is called an arc height. According to the ALMEN arc height measurement method, the first shot peening strength in this embodiment is 0.16 mmA, and the second shot peening strength is 0.21 mmN.

### 2. Molybdenum Disulfide Micro-Particle Thermal Spraying Treatment

The molybdenum disulfide micro-particle thermal spraying treatment is continued on the gear surface treated by the compound shot peening in the step 1. The specific steps are as follows.

### 2.1 Preparation Step

True spherical grinding shots with a multi-particle diameter of 30-200 μm are put into the aggregate cabin of the spraying device, and a solid molybdenum disulfide lubricant and the true spherical grinding shots are injected into the aggregate cabin according to a mass ratio of 20:1.

The above-mentioned true spherical grinding shots are ceramic shots with the diameter of 50 μm and the hardness of 58-63 HRC.

### 2.2 Preheating Step

The aggregate cabin is heated to 100° C. by the heater, and the solid molybdenum disulfide lubricant is fully mixed with the true spherical grinding shots.

The solid molybdenum disulfide lubricant and the true spherical grinding shots are added according to a certain weight ratio, and preheated at a certain temperature, so that the solid molybdenum disulfide lubricant may be mixed with the true spherical grinding shots more evenly, and a lubricity of the true spherical grinding shots may be improved at the same time.

### 2.3 Gas Conversion Step

After outside air is compressed by the air compressor, gas is introduced into the gas generator to generate inert gas nitrogen. The gas generator is connected with the first nozzle arranged in the operation cabin and the cooler which may reduce the temperature of the inert gas. The gas generator introduces the inert gas into the first nozzle and the cooler, and the cooler is used to cool the inert gas. In this embodiment, the low-temperature inert gas sent from the cooler is 0° C.

### 2.4 Spraying Step

The cooler is communicated with the second nozzle arranged in the operation cabin, and the first nozzle is communicated with the aggregate cabin. The low-temperature inert gas (0° C.) sent by the cooler is sprayed onto the gear surface by the second nozzle, and the inert gas generated by the gas generator pushes grinding balls for spraying processing, so that the gear surface is impacted by the shots to form a plurality of holes and generate crumb dust. During the spraying process, an inside of the operation cabin is in a low oxygen state, and the shot peening strength is 0.3 MPa and the shot peening duration is 30 seconds.

### 2.5 Recovery Step

The exhaust assembly is used to recycle the impacted shots to the aggregate cabin, and the dust is transported to the collector connected with the operation cabin. The collector has a cabin body connected with the operation cabin and the filter screen arranged in the cabin body, and the filter screen is used to filter the recycled dust.

### Embodiment 2

Same as embodiment 1, the difference is that in the step 1.3, the first shot peening pressure is 0.45 MPa, the first shot diameter is 0.2-0.25 mm, the second shot peening pressure is 0.25 MPa, and the second shot diameter is 0.1-0.15 mm, so the shot flow rate of the first shot peening and the second shot peening is 6 kg/minute; the shot peening coverage is set to 180%, the duration of the two shot peening is set to be 150 seconds, and the spraying distance is set to be 150 mm; in the step 2.1, the solid molybdenum disulfide lubricant and the true spherical grinding shots are injected into the aggregate cabin according to the mass ratio of 30:1; in the step 2.2, the aggregate cabin is heated to 150° C. by the heater; and in the step 2.4, the shot peening strength is 0.4 MPa and the shot peening duration is 40 seconds.

### Embodiment 3

Same as embodiment 1, the difference is that in the step 1.3, the shot peening angle for the two shot peening treatments is 80°; the first shot peening pressure is 0.4 MPa, the first shot diameter is 0.2-0.25 mm, the second shot peening pressure is 0.2 MPa, and the second shot diameter is 0.1-0.15 mm, so the shot flow rate of the first shot peening and the second shot peening is 4 kg/minute; the shot peening coverage is set to 220%, the duration of the two shot peening is set to be 110 seconds, and the spraying distance is set to be 150 mm; in the step 2.1, the solid molybdenum disulfide lubricant and the true spherical grinding shots are injected into the aggregate cabin according to the mass ratio of 25:1; in the step 2.2, the aggregate cabin is heated to 200° C. by the heater; and in the step 2.4, the shot peening strength is 0.5 MPa and the shot peening duration is 50 seconds.

### Comparative Example 1

Only the carburizing and quenching heat treatment is carried out to the low-carbon alloy steel gears. The compound shot peening and the molybdenum disulfide micro-particle thermal spraying are not carried out.

### Comparative Example 2

Same as embodiment 1, the difference is that only the first shot peening is performed in the step 1, and the second shot peening is omitted. Other steps and the amount of materials are the same as those in embodiment 1.

### Comparative Example 3

Same as embodiment 1, the difference is that only the second shot peening is performed in the step 1, and the first shot peening is omitted. Other steps and the amount of materials are the same as those in embodiment 1.

### Comparative Example 4

Same as embodiment 1, the difference is that only the step 1 is carried out, and only the compound shot peening is carried out on the gear surface, and the molybdenum disulfide micro-particle thermal spraying is not carried out.

### Comparative Example 5

Same as embodiment 1, the difference is that only the step 2 is carried out, and only the molybdenum disulfide micro-particle thermal spraying treatment is carried out on the gear surface, and compound shot peening treatment is not carried out.

### Effect Verification

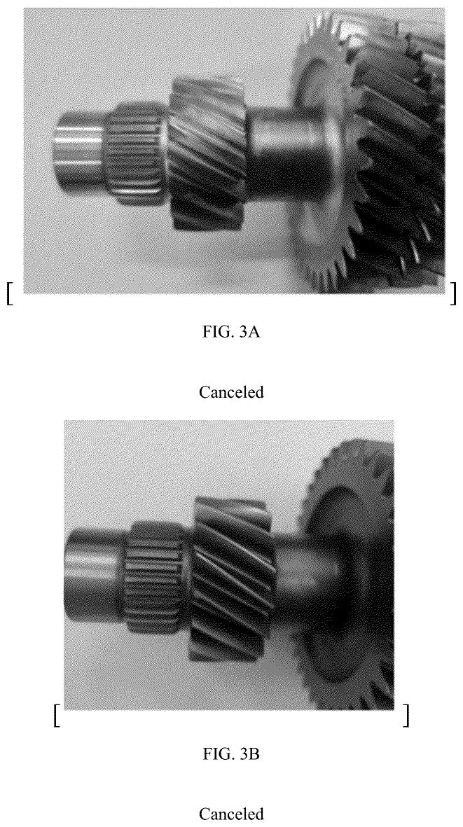

An appearance of the gear before the treatment in embodiment 1 (the low-carbon alloy steel gear after the carburizing and quenching heat treatment) is shown in FIG. 3A, and an appearance of the gear after a strengthening treatment by the method of embodiment 1 is shown in FIG. 3B. It may be seen from FIG. 3A and FIG. 3B that a gloss of a gear tooth surface after the strengthening treatment is darkened and blackened.

In order to verify the influence of a compound small-diameter shot peening+molybdenum disulfide micro-particle thermal spraying process on a gear surface performance, the gear performances before and after the strengthening treatment in embodiment 1 are compared, and the surface residual stress, the roughness and the hardness are tested respectively.

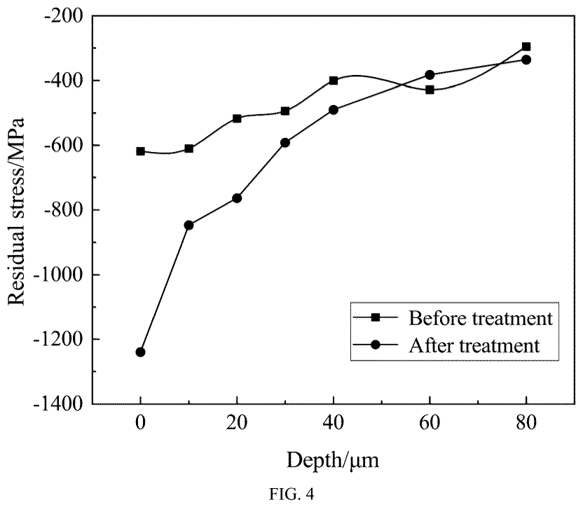

An X-ray diffraction method is used to detect the residual stress on the gear surface. A detection environment is a room temperature, and a detection position is at an upper edge of a fillet of a tooth root. A depth of the residual stress measured by the X-ray diffraction is 10 μm. In order to obtain residual stress values of different depths on surface layers of the gear, the residual stresses of the gear at different depths are measured by an electrolytic polishing method. An electrolyte is a saturated sodium chloride solution, and surface materials are removed by electric polishing. A comparison of the residual stresses of the gear before and after the treatment in embodiment 1 is shown in FIG. 4. From a curve in the figure, it may be seen that the residual compressive stress on the gear surface after the compound small-diameter shot peening+molybdenum disulfide micro-particle thermal spraying has been greatly improved, which is helpful to reduce the influence of a surface contact force during gear transmission, thus extending a fatigue life of the gear.

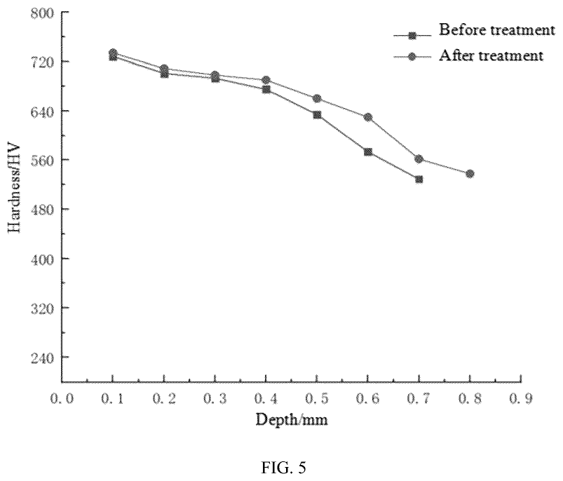

The hardness of the gear surface is measured by a Vickers hardness (HV) measuring instrument. The Vickers hardness is pressed into the gear surface with a load within 120 kg and a diamond square cone with a vertex angle of 136°. The Vickers hardness is obtained by dividing a surface area of an indentation pit of the gear by a load value. Hardness test results of the gear surface before and after the treatment in embodiment 1 are shown in FIG. 5. From the curve in the figure, it may be seen that the surface hardness of the gear after the compound small-diameter shot peening+molybdenum disulfide micro-particle thermal spraying is higher, which is more helpful to inhibit generation of surface cracks of the gear, thus extending the fatigue life of the gear.

### Contact Fatigue Life Test:

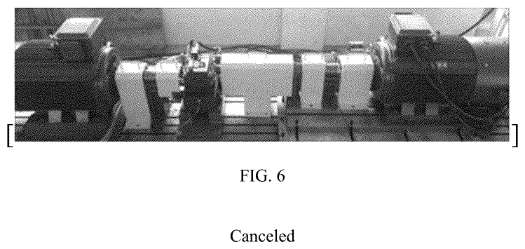

In order to verify the influence of the above test results on the fatigue life, the fatigue life test is carried out on the gear before and after the treatment in embodiment 1. A test bench used for the fatigue life test is a gear fatigue endurance test bench, as shown in FIG. 6.

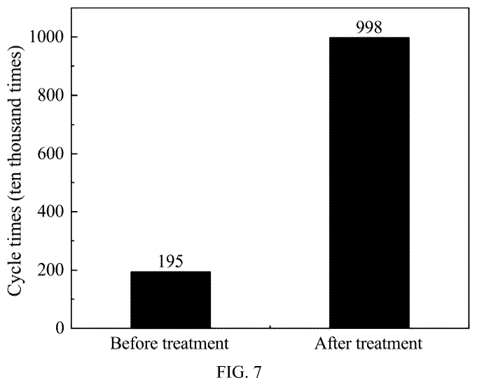

The gear before and after the treatment in embodiment 1 is tested with same data parameters, with a rotation speed of 2500 r/minute, a torque of 230 Nm and an oil temperature of 80° C., and the fatigue life is determined by the time (number of cycles) of tooth surface pitting. The fatigue life of the gear before and after the treatment in embodiment 1 is shown in FIG. 7. It may be seen from the data in the figure that the service life of the gear treated by the compound small-diameter shot peening+molybdenum disulfide micro-particle thermal spraying is 5.1 times that of the gear before the treatment, and the fatigue life has been greatly improved. The results are consistent with the above conclusions.

### Friction Coefficient Test:

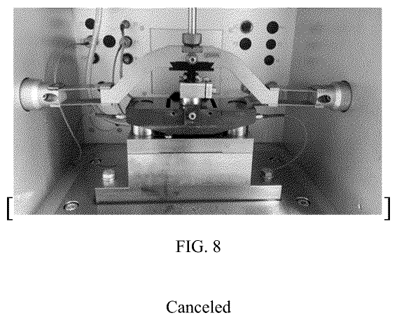

The friction coefficient test is carried out by a SRV testing machine of Optimol Instrument Company in Germany, and the SRV testing machine is mainly composed of a test part, a heating control part, a lubricant supply and circulation device, a smoke exhaust device, a SRV control and a software analysis and printing device. The SRV testing machine of Optimol Instrument Company in Germany is shown in FIG. 8, and a movement mode of the SRV testing machine is ball counting contact. Test parameters are shown in a table, and an average value of the friction coefficients is taken.

The parameters used in SRV test of an Optimal Schwing-Reib-Verschleiss-5 multifunctional friction and wear tester are shown in Table 1:

TABLE 1

| Test parameter | Line contact |
|---|---|
| Load (N) | 300 |
| Test time/s | 3600 |
| Test temperature/° C. | 80 |
| Frequency/Hz | 50 |
| Sliding speed/m · s⁻¹ | 0.1 |
| Oil/ml | 0.3 |

Performance test results of the gears treated in the same way as above in embodiments 2-3 and Comparative examples 1-5 are shown in Table 2. The surface residual stress refers to the depth of 0 μm; a surface hardness also refers to the Vickers hardness with the depth of 0.1 mm.

TABLE 2

| | Performance | | | |
|---|---|---|---|---|
| | Surface | | | Cycle |
| | residual | Surface | Surface | times (ten |
| | stress | hardness | friction | thousand |
| Number | (MPa) | (HV) | coefficient | times) |
| Embodiment 1 | −1356 | 735 | 0.121 | 998 |
| Embodiment 2 | −1385 | 732 | 0.123 | 1088 |
| Embodiment 3 | −1346 | 728 | 0.125 | 985 |
| Comparative | −612 | 721 | 0.15 | 195 |
| example 1 | | | | |
| Comparative | −1206 | 725 | 0.132 | 865 |
| example 2 | | | | |
| Comparative | −942 | 719 | 0.128 | 454 |
| example 3 | | | | |
| Comparative | −1304 | 731 | 0.138 | 881 |
| example 4 | | | | |
| Comparative | −746 | 683 | 0.126 | 486 |
| example 5 | | | | |

The above are only the preferred embodiments of the application, and the scope of protection of the application is not limited thereto. Any equivalent substitutions or changes made by any person familiar with the technical field according to the technical scheme and inventive concept of the application shall fall in the scope of protection of the application.

1. A method for a compound strengthening treatment of a gear surface, comprising: firstly, performing a compound shot peening treatment on the gear surface with a diameter of 0.2-0.25 mm, and then performing molybdenum disulfide micro-particle thermal spraying on the shot peened surface to complete the compound strengthening treatment on the gear surface with a diameter of 0.1-0.15 mm, wherein a shot peening angle of the two shot peenings is 80-100°, a shot flow rate is 4-6 kilograms (kg)/minute, and a spraying distance is 150-170 mm; and a shot peening coverage is 180-220%.

2. (canceled)

3. (canceled)

4. The method according to claim 21, wherein the shots used in the two shot peenings are cast steel shots or ceramic shots; a hardness of the cast steel shots or the ceramic shots is 58-63 HRC.

5. The method according to claim 1, wherein a raw material used for the molybdenum disulfide micro-particle thermal spraying is a molybdenum disulfide solid lubricant, and the molybdenum disulfide solid lubricant is mixed with shots with a particle size of 0.03-0.2 mm to form the molybdenum disulfide micro-particles.

6. The method according to claim 5, wherein the shots are ceramic shots, and a mass ratio of the molybdenum disulfide solid lubricant to the ceramic shots is 20-30:1.

7. The method according to claim 1, wherein an inert gas is used as a carrier gas of the molybdenum disulfide micro-particles during the molybdenum disulfide micro-particle thermal spraying.

8. The method according to claim 7, wherein a shot peening pressure is 0.3-0.6 MPa and a shot peening duration is 30-50 seconds in the thermal spraying.
